(19) United States
(12) Patent Application Publication
(10) Pub. No.: US 2014/0222514 A1
(43) Pub. Date: Aug. 7, 2014

(54) Graphical User Interface for Collecting Explicit and Non-Explicit Information in Electronic Surveys

(71) Applicant: Survature Inc., Knoxville, TN (US)

(72) Inventors: Jian Huang, Knoxville, TN (US); Steven C. Chin, Knoxville, TN (US)

(73) Assignee: Survature Inc., Knoxville, TN (US)

(21) Appl. No.: 14/172,658

(22) Filed: Feb. 4, 2014

Related U.S. Application Data
(60) Provisional application No. 61/760,447, filed on Feb. 4, 2013.

(51) Int. Cl. G06Q 30/02

(52) U.S. Cl. CPC G06Q 30/0203
USPC 705/7.32

(57) ABSTRACT

A system for conducting electronic surveys comprises a processing device coupled to a network. The processing device is configured to provide a graphical user interface (“GUI”) defining an electronic survey. The GUI defines a survey page comprising a first region including a plurality of different objects selectable by a user taking the survey. The GUI also defines a second region defining a first portion assigned a first relative rating on a rating scale and a second portion assigned a second relative rating, for selective placement of objects from the first region by the user. The GUI provides data related to the placement of each object into the first and second portions by the user, while continuing to display each selection on the same survey page. The processing device also derives explicit and non-explicit information related to the placement of respective objects. A method and GUI are also disclosed.

### RELATED APPLICATION

The present application claims the benefit of U.S. Provisional Patent Application No. 61/760,447, which was filed on Feb. 4, 2013, is assigned to the assignee of the present inventory and is incorporated by reference herein.

### FIELD OF THE INVENTION

The present invention relates to electronic surveys, and, more particularly, a graphical user interface for conducting Likert scale questions in which the graphical user interface can collect additional, non-explicit information.

### BACKGROUND OF THE INVENTION

Many companies use electronic surveys to collect information from customers, respondents, audiences, and end users. Electronic surveys have many distinct advantages over traditional paper surveys. For example, electronic surveys can reach more customers through the Internet and by email. Electronic surveys can also dynamically populate answer choices using drop down boxes and collect virtually unlimited information using text or essay boxes.

Electronic surveys can take advantage of a combination of traditional question types and electronically generated question types. Electronic surveys often present an array of question types, including multiple-choice questions with one or more answers, open-ended questions with single or multiple text boxes for customers to type in their responses, Likert rating scales, selection lists from drop down menus, and image manipulation. Some of the newer electronic surveys allow for drag and drop rankings.

There are generally two types of questions in surveys: 1) structured or fixed questions, and 2) unstructured or open questions. As an example of the different and common question types, suppose an online gift store presents an electronic survey to one of its customers to gather information about what the customer thinks about its service and the customer's demographic information. The online store asks the following questions:

Did you find the item you were looking for? [Question type: multiple-choice with one answer.]
a. Yes.
b. No.

Would you recommend this service to a friend? [Question type: Likert rating question.]
a. Very likely
b. Somewhat likely
c. Neutral
d. Somewhat unlikely
e. Very unlikely

How would you rate this service from a scale of 1 through 10 with 10 being the best?[Question type: rating scale.]

| 1 | 2 | 3 | 4 | 5 | 6 | 7 | 8 | 9 | 10 |
|---|---|---|---|---|---|---|---|---|---|
| ◯ | ◯ | ◯ | ◯ | ◯ | ◯ | ◯ | ◯ | ◯ | ◯ |

Why did you buy this gift? You can choose multiple answers. [Question type: multiple-choice with multiple answers.]
a. Anniversary
b. Birthday
c. Christmas
d. Congratulations
e. Get better
f. Holiday
g. House warming
h. Reward
i. Thank you
j. Wedding
k. Welcome
l. Other

Which state do you live in? [Question type: select from drop down menu.]

Please select:
AK
. . .
WY

Please rank the following items in terms of importance as to why you chose to use this service with top being the most important. Drag and drop with the highest rank on top. [Question type: drag and drop ranking.]
a. Reasonable prices
b. Availability and wide selection of products
c. Reputation
d. Customer service
e. Convenience and return policy

Please comment on how we can do better. [Question type: free form text box]
a. Comment/Text/Essay box.

Another type of electronic survey is referred to as a card sorting survey, where content items, referred to as card, are presented to a user on a display of a device. The user sorts the cards into categories that are also displayed on the display. In known sorting surveys, results are submitted for processing when an entire survey or a page of the survey, is completed. Examples of electronic card sorting surveys include Optimal Sort from Optimal Workshop (Optimal Products Ltd.), Wellington, New Zealand; SurveyGizmo from Widgix, LLC, Boulder, Colo.; Kinesis Survey™ from Kinesis Survey Technologies, Austin, Tex.; and the Card Sorting tool from Userzoom, Sunnyvale, Calif.

### SUMMARY OF THE INVENTION

The traditional electronic surveys described above are suited to collect explicit responses, which are pairings of questions and responses. But while these surveys can take advantage of web-enabled tools, such as dynamically populated drop down boxes, drag and drop rankings, and image manipulation, these surveys have fundamental limitations. For example, these electronic surveys are numerically ordered, linear, and not user-directed. Even though the survey creator may not necessarily require all questions to be answered, there is a predetermined order for the survey taker or the user (hereinafter the “user”) to respond to the survey. Every user must work through the survey in a particular order by answering the first to last question in the predetermined, fixed order of first question with first response, second question with second response, third question with third response, and so forth. Furthermore, if the survey has a multitude of questions of the same set of responses, the user must complete one page before going to the next page and may spend an enormous time completing the entire survey. In addition, in structured or closed questions, the survey taker must answer according to predetermined choices and cannot add unique responses if the user believes that there is a better response or additional responses that the user can provide.

As such, these surveys do not permit a user to direct the order in which the questions are answered, how to respond, and whether the user wants to include additional responses, and other information related to the user's process or behavior in taking the survey. Such procedural, behavioral information is referred as non-explicit information, in contrast to explicit information, which is the survey answer, itself. Non-explicit information may provide valuable insights into the degree of confidence, importance, and relevance the user attaches to each response. Non-explicit information includes whether and how often the user changes responses during a polling period, how long it takes to answer a question, and other information not explicitly elicited from the user. Additional examples are discussed below.

Non-explicit responses are valuable because this information can provide insights into the process of how the user responded to the survey and the degree of confidence, importance, and relevance the user attaches to each response. Non-explicit responses also provide information on whether the user was careless on any of his responses or whether the user faked any of his responses. If the survey analyst were to compare the results of surveys across groups of users, the patterns and rankings of explicit and non-explicit responses may provide further insights into group behavior and demographics.

In accordance with one embodiment of the invention, a graphical user interface (“GUI”) for an electronic survey is provided that allows the user to respond to questions in the order that the user decides, to respond to the only questions that the uses desires, and/or to permit the user to provide unique responses that were not included in the initial GUI survey. The graphical user interface provides information enabling a determination of how quickly a user forms each response and whether and how often the user changes responses, for example. The GUI may also allow the user to input unique responses and to identity those unique responses, for example.

Surveys in accordance with embodiments of the invention reverse what is typically understood as the questions and the responses. In the traditional survey, a question or a statement is presented and the survey taker is asked to select a response from a prescribed set of responses. FIG. 1 is an example of a typical prior art survey 10 with Likert scale questions 12, where a question is followed by a response options 14. The questions 12 are numbered. The user taking or responding to the survey answers each question until all the required questions are complete before moving to the next set of questions or until the survey is complete. In this example, the user is asked whether they love, like, are neutral to, dislike, or hate particular foods. Often, the survey is broken up into multiple pages so that the user does not see all of the questions and responses on one page. The user must complete each page before navigating to the next page and until the entire survey is complete.

In the example of FIG. 1, Likert scale questions 12 are provided with prescribed response options or answers 14, such as:
(1) Do you like apples? Please select one of the following responses: I (a) love, (b) like, (c) am neutral, (d) dislike (e) hate.
(2) Do you like bananas? Please select one of the following responses: I (a) love, (b) like, (c) am neutral, (d) dislike (e) hate.
(3) Do you like carrots? Please select one of the following responses: I (a) love, (b) like, (c) am neutral, (d) dislike (e) hate.

In accordance with embodiments of the invention, instead of requiring a user to select an answer from limited, fixed choices, as in the prior art, the user classifies objects, such as names or images of fruits and vegetables, for example, under particular categories in a rating scale. In electronic surveys in accordance with embodiments of the invention, prescribed responses or Likert scales of (a) love, (b) like, (c) neutral, (d) dislike, and (e) hate in the traditional electronic survey are provided for response boxes, while the main part of the questions of apples, bananas, and carrots, etc. are provided as selectable GUI objects. The user then responds to a question such as: “Which of the following do you like . . . .” The GUI allows the user to select, drag, and drop the “apples,” “bananas,” and “carrots” objects in the appropriate response boxes. If the user likes apples, then the user can select, drag, and drop the “apple” object into the “like” response box. If the user loves “bananas,” then the user can select, drag, and drop the “bananas” object into the “love” response box. If the user has no opinion about “carrots,” then the user can simply leave the “carrot” object alone. A prior art survey may be converted into a survey in accordance with embodiments of the invention by factoring out the prescribed responses or Likert scales and formatting them into response boxes, while factoring out the subjects of the questions, and converting them into selectable GUI objects that can be selected and placed in an appropriate response box by the user.

In accordance with another embodiment of the invention a user may type in additional responses that are not initially provided. For example, suppose the user dislikes artichoke and hates broccoli. The user can type in the word artichoke in a response box for “dislike” and type in the word broccoli in a response box for “hate.”

In one embodiment, the system records every action, activity, and event by the user during the polling period, which is the period between the start and end time when the user is responding to the survey. For example, the system records the order in which the user responds to a question and/or statement, how long the user takes to make each response, whether the user changes his response, and/or all the user-provided responses. By recording the process in which a user iteratively and freely chooses which answers to provide or not provide, the order of the responses, and the frequency that the user changes and refines the responses, will provide insights into the degree of confidence, importance, relevance, care, and honesty the user attaches to each response.

By reversing the typical survey's form of question and answer in Likert scale questions, allowing the user to answer questions selected by the user, add unique responses, and/or order responses, the user can direct the process of responding to questions in the survey and provide a complete response from the survey taker's perspective. It also removes the limitations of traditional electronic surveys where the survey maker must anticipate all the likely questions and responses, because the user cannot insert their own answers.

A survey set is a group of survey pages forming a complete survey. A survey set may be an employee survey, a consumer survey, a market surveys, a personality test, a research survey, etc. Each of these survey sets may contain many different survey questions that poll a survey topic. Surveys are created by “survey creators,” who design, create, run, and/or administer the survey.

In accordance with an embodiment of the invention, a system for conducting electronic surveys is disclosed comprising a processing device coupled to a network and storage. The processing device is configured to provide a graphical user interface defining a survey for presentation on a display of a computing device for a user taking the survey, via the network. The graphical user interface is configured to define at least one survey page comprising a first region including a plurality of different objects selectable by a user taking the survey, wherein the objects are related to a survey question. The graphical user interface is further configured to define a second region separate from the first region, where the second region defines at least a first portion assigned a first relative rating on a rating scale and a second, different portion assigned a second, different relative rating on the rating scale, for selective placement of objects from the first region by the user, in response to the question. The graphical user interface is further configured to provide data related to the placement of each object into the first and second portions by the user, via the network, while continuing to display each selection on the same survey page. The processing device is further configured to store the data in memory, derive explicit information identifying the relative rating on the rating scale for each placed object, from the stored data, and derive additional, behavioral information related to the placement of respective objects, from the stored data. The additional, behavioral information may comprise an order of placement of objects, changing a placement of an object, and/or a length of time to place a selected object, for example.

In accordance with another embodiment of the invention, a method for conducting an electronic survey is disclosed comprising providing a graphical user interface defining a survey page to a computing device for display to a user taking the survey, by a processing device, via a network, and receiving a placement of a selected object into one of at least two portions of a second region separate from the first region, by the user in response to the question, by the processing device via the network. Each of the at least two portions are assigned a relative rating on a rating scale. The method further comprises storing the data in memory, deriving explicit information identifying the relative rating on the rating scale for each placed object from the stored data, by the processing device, and deriving additional, behavioral information related to the placement of respective objects from the stored data, by the processing device.

In accordance with another embodiment of the invention, a graphical user interface for conducting electronic surveys via a display of a computing device is disclosed comprising a first region including a plurality of objects selectable by a user taking the survey, where the objects are related to a survey question. A second region is provided separate from the first region, where the second region defines at least a first portion assigned a first relative rating on a rating scale and a second, different portion assigned a second, different relative rating on the rating scale, for selective placement of objects from the first region by the user, in response to the question. The graphical user interface is configured to store on the computing device data related to the placement of each object into the first and second regions by the user, for each placement, while continuing to display each selection on the same survey page.

### BRIEF DESCRIPTION OF THE DRAWINGS

The present invention is illustrated by way of example, and not by way of limitation, in the figures of the accompanying drawings:

FIG. 1 is an example of a traditional electronic survey with numerically ordered Likert scale questions and responses;

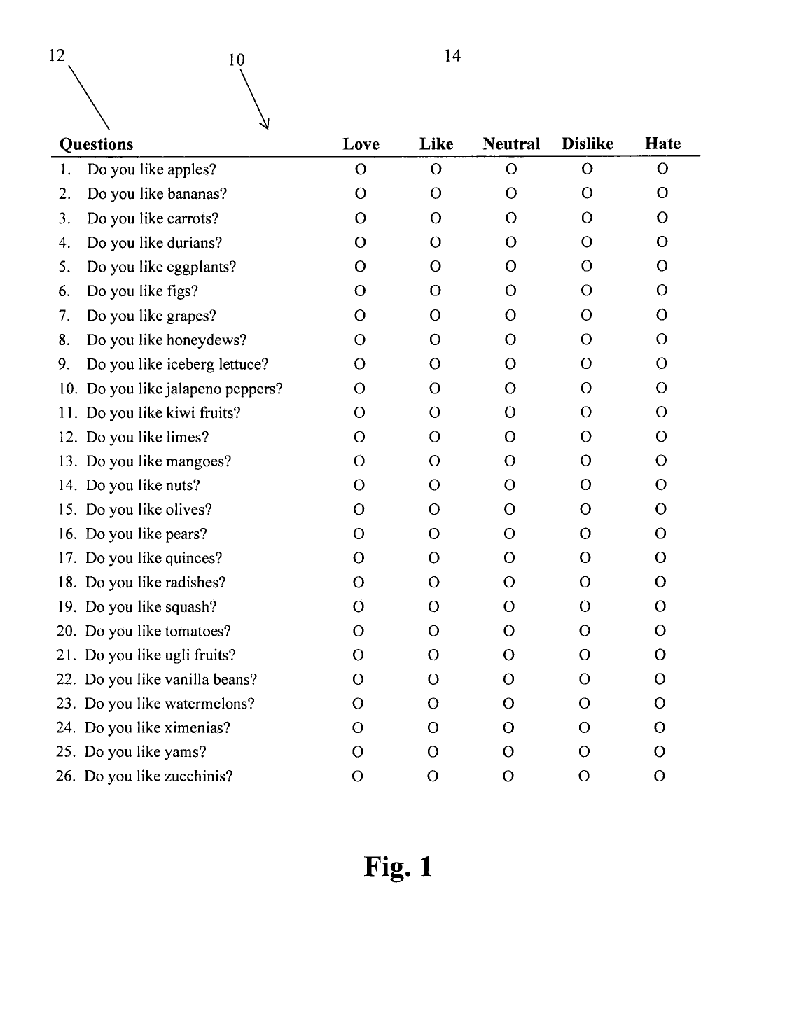

FIG. 2 is a systems diagram of an embodiment of the present invention;

FIG. 3 is an example of an electronic survey corresponding to the survey of FIG. 1, presented by a graphical user interface in accordance with an embodiment of the invention;

FIG. 4 is an example of the graphical user interface of FIG. 3, where a user has partially filled out the survey;

FIG. 5 is another example of a traditional electronic survey with numerically ordered Likert scale questions and responses;

FIG. 6 is another example of an electronic survey corresponding to the survey in FIG. 5, presented by a graphical user interface in accordance with an embodiment of the invention;

FIG. 7 is a flow chart of an example of a process for presenting the graphical user interface and recording responses from the user during by a browser of a user's computing device; and

FIG. 8 is a flow chart of an example of a process for processing and analyzing survey results, in accordance with an embodiment of the invention.

### DETAILED DESCRIPTION

1. Graphical User Interface

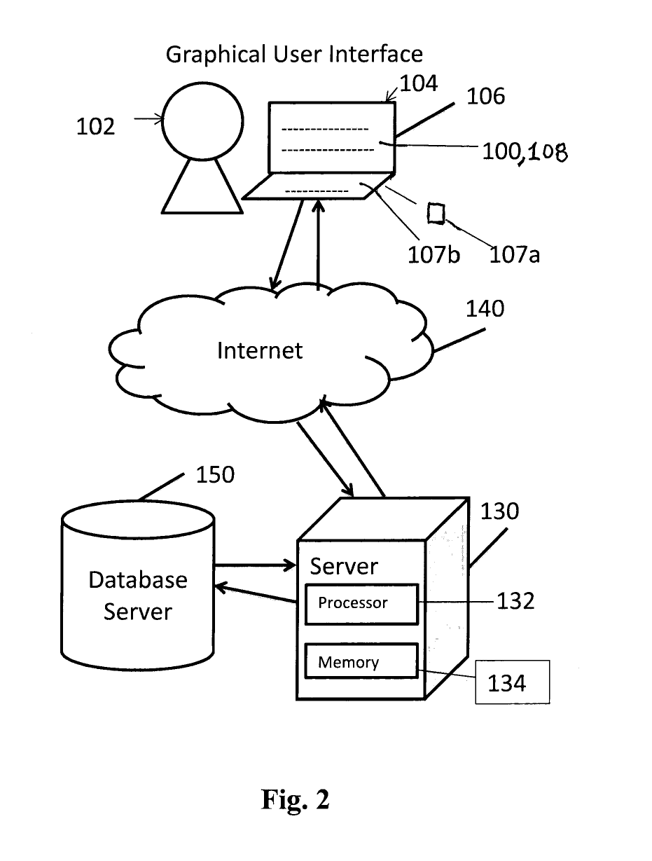

FIG. 2 is a system diagram of an embodiment of the present invention, in which a user 102 is next to a computing device 104 having a display 106 and an input device 107, such as a mouse 107a or a keyboard 107b. The user 102 takes a survey 108, which is displayed on the display 106 in the form of a graphical user interface (“GUI”) 100. The GUI 100 and the survey 108 are provided to the user's computing device 104 by a web server 130 via a network 140, such as the Internet, for example. A database server 150 or other storage device is coupled to or is a part of the server 130. The server 130 includes a processing device 132, such as a computer, microcontroller, or microprocessor, for example, and memory 134. The term “server” is broadly defined and means either a processing device, such as physical computer, or a virtual server defined by a processing device, such as computer.

To construct, populate, paint, present, or display the GUI 100 on the display 106 of the computing device 104, the server 130, under the control of a software application stored in the memory 134, pulls information from the database 150. The server 130 provides the information, including Javascripts, to the computing device 104 via the network 140, which constructs the GUI 100 via a browser based on the information, in a manner known in the art.

The user's computing device 104 may be a desktop computer, a laptop, a tablet, a smartphone, or any other computing device with a display 104, which can be coupled to the network 140. If the computing device 104 has a touchscreen, it may also be used as an input device 107. The computing device 104 includes a processing device (not shown), such as a microprocessor or microcontroller, and memory (not shown).

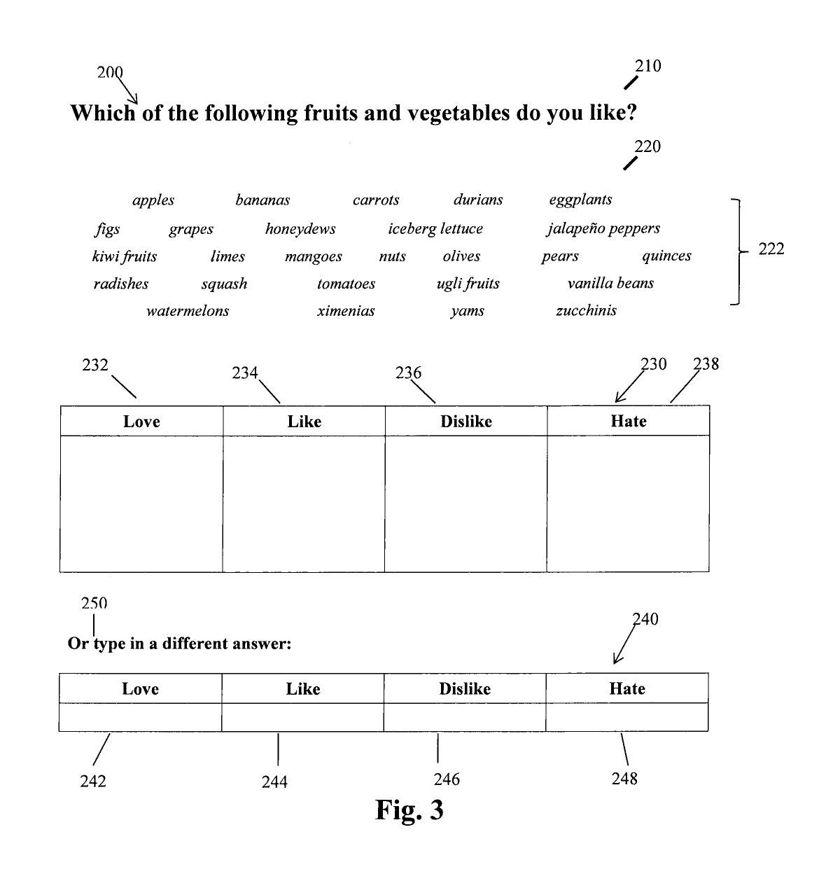

FIG. 3 is an example of a graphical user interface (“GUI”) 200 that may be displayed by a web browser on the display 106 of the computing device 104 to enable a user 102 to take a survey 108, in accordance with an embodiment of the invention. In this example, the GUI 200 provides a narrative space 210, an overview space 220, a response space 230, and an optional input space 240.

The narrative space 210 can be short and simple or long and descriptive, or any combination. The narrative space 240 provides the instructions or describes the story, question, narrative and/or topic of the survey. It is usually provided by the GUI 200 at a top of each survey set or survey page, but that is not required. The narrative space 210 may also be presented in a separate page or window before the user proceeds to respond to the survey. In this example, the narrative space 210 in FIG. 3 includes the question “Which of the following fruits and vegetables do you like?”

The overview space 220, which in this example is below the narrative space 210, contains response objects 222 corresponding to that particular topic. In general, the response objects 222 may be words, phrases, sentences, images, or any type of GUI object that a user can select with an input device 107. In this embodiment, the response objects 222 are words, such as apples and bananas, and groups of words, such as iceberg lettuce and jalapeño peppers, for example. In another example, the response objects 222 may be images of the fruits and vegetables. Also in this example, the response objects 222 in the overview space 220 are arranged in alphabetical order (from A through Z), but the response objects need not be arranged in any particular order. The only requirement is that each response object is a discrete object so that a user can identify and select it.

A response space 230 is provided for placement of respective response objects 222. In this embodiment, the response space 230 is divided into four containers 232, 234, 236, 238 corresponding to predetermined responses and indicating how the user may respond to the question: “Which of the following fruits and vegetables do you like?” or other questions.

Each of these containers 232-238 have a specific rating, as in a Likert scale. Here, the Likert ratings or scales are “love,” “like,” “dislike,” and “hate.” Other scales may be used and/or the response space may be grouped in distinct circles or other distinctive shapes for creating response containers. In this example, the user 102 may select respective response objects 222 in the overview space 220 and then drag and drop each response object into the appropriate container 232-238, depending on whether he loves, likes, dislikes, or hates a particular fruit or vegetable.

This example does not provide a response of “neutral” because it is assumed that if the user does not have an opinion about a particular fruit or vegetable, the user will simply decide not to respond. A non-response may be interpreted as not eliciting a strong enough opinion for the user 102 to place the response object 222 in a love, like, dislike, or hate response box 232-238 respectively. A neutral option may also be provided.

An input space 240 may also be provided for the user to enter unique responses not listed among the response objects 222 in the overview space 220, as shown in FIG. 3. In this embodiment, the input space 240 is divided into four text fields 242, 244, 246, 248 that correspond to the four containers 232-238 in the response space 230. An instruction field 250, for example, is also provided to, in this example, inform the user 102 to “type in a different answer.” In other embodiments, the input space can be any type of input field, including but not limited to text boxes, comment boxes, buttons to upload pictures, buttons to record sounds, or buttons to open up new input field, box, window, or page. The user can add a unique response that is not provided in the overview space by typing, inputting, or uploading a new response object. In this embodiment, the user's additional response object may be a word or a phrase. In some embodiments, there is no input space 240 because the survey creator did not want to provide such an option.

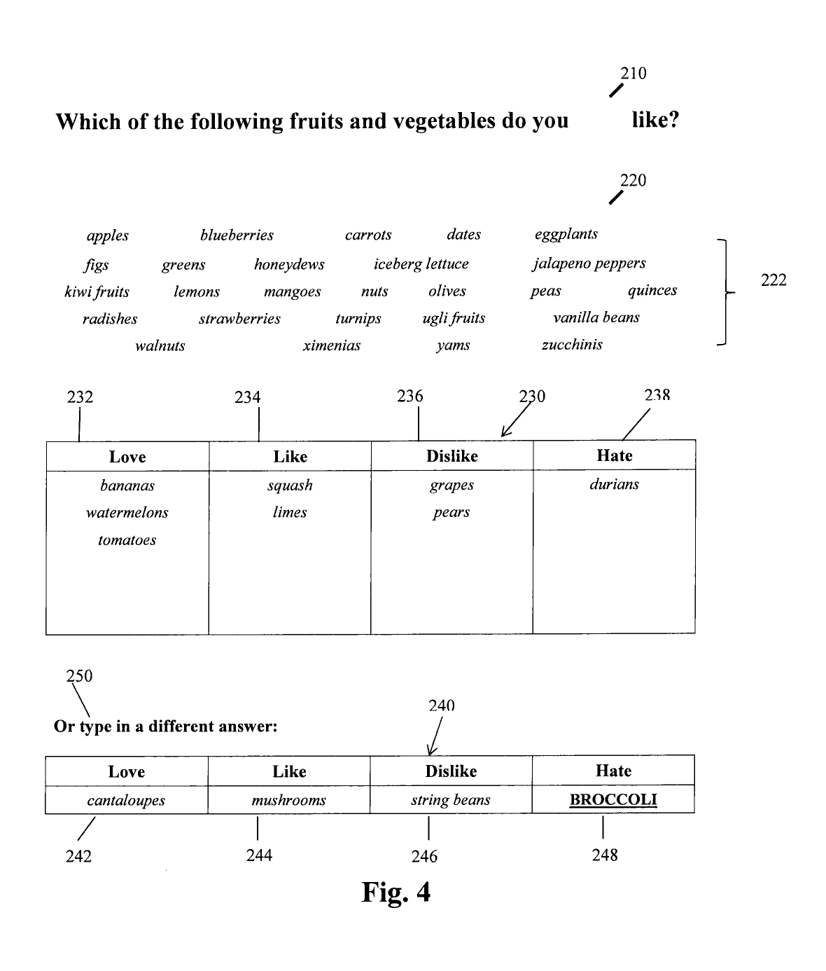

FIG. 4 is an example of the GUI 200 after being at least partially completed by a user 102. As shown in FIG. 4, the user selected the Bananas, Watermelons, and Tomatoes response objects 222 from the overview space 220, and dragged and dropped the selected response items in the response space 230 under the “Love” container 232. The user selected the Squash and Limes response objects 222 from the overview space 220, and dragged and dropped them in the response space 230 under the “Like” container 234. The user 102 selected the Grapes and Pears response objects 230 from the overview space 230 and dragged and dropped them in the response space 230 under the “Dislike” container 236. The user 102 selected the Durian response object 222 from the overview space 220 and dragged and dropped it in the response space 230 under the “Hate” container 238.

In one embodiment of the present invention, the survey creator may add the option to have the survey dynamically add new response objects in the overview space 220 each time the user selects a response object and moves it to the response space 230. In the example in FIGS. 3 and 4, after the user selects Bananas, Watermelons, and Tomatoes, the GUI is configured to introduce Blueberries to the area where Bananas used to be, Walnuts to the area where Watermelons used to be, and Turnips to the area where Tomatoes used to be, and so forth with Squash, Limes, Grapes, Pears, and Durians. That a word with the letter “B” replaced a selected word with a letter “B” is for illustrative purposes only.

If the survey creator decides not to select the option for the survey page to dynamically add new response objects, then as the user 102 selects, drags, and drops respective response objects 222 into the response space, the number of response objects in the overview space diminishes with each response.

The survey creator could also decide to have a limited number of new response objects appear. For example, the survey creator could select that only twenty response objects shall appear at any one time in the overview space and with a limit of thirty response objects for the survey. For the first ten response objects that the user 102 selects, ten additional response objects will replace those selected. But after the tenth, because there are no additional response objects, then the number of response objects in the overview space will diminish in relation to the number of additional response objects that the user selects. These numbers are merely exemplary.

The user 102 may also add unique responses in the input space 240. For example, the user 102 may place a cursor in the “Love” input field 242, and type the word “cantaloupes” in the response space 230, via the user's input device 107. Hitting the Enter key or other such key, button, or indicator, enters the new object “cantaloupes” into the survey page. In FIG. 4, the user 102 has similarly entered “mushrooms” in the “Like” field, “string beans” in the “Dislike” input field, and “BROCCOLI” in the “Hate” input field. The GUI 100 may be configured to collect the font of the input word, as well. In this example, BROCCOLI is capitalized and in bold, which may be interpreted as emphasizing the hatred of broccoli by the user 102.

This embodiment of the present invention allows a user 102 to change responses. For example, if the user 102 wants to change or delete a response that has been placed in a response space 230, such as tomatoes in the “Love” container 232 in FIG. 4, the user may select the respective response object 222 in the respective response space 232-238 by the input device 107 and change the answer by deleting it or dragging it back to the overview space 220 or to another container. If the answer is deleted, the GUI 100 may be configured to return the corresponding object to the overview space 220. The user 102 may do this for any response objects that has been selected and placed in a category, until the survey page is completed and submitted by hitting a Next Page button on the GUI 100, for example.

As the user is selecting respective response objects 222 and dragging and dropping the objects into respective response spaces 232-238, and as the user is inputting his unique responses in the input space 240, the application is collecting the user's explicit responses. Collection may be triggered by selection of an object and dropping of the object, which may be collected by a Javascript thread, for example, and/or hitting an Enter button on a keyboard 107a or on a touchscreen display the computing device 104, for example. Words input into a container 242-248 may be collected upon hitting the Enter button or other such affirmative action, for example.

Explicit responses are the pairings between a particular response object and its corresponding response container or scale. In reference to FIG. 4, the explicit responses or pairings are Love-Banana, Love-Watermelons, Like-Squash, Like-Limes, Dislike-Grapes, Dislike-Pears, Hate-Durians, Hate-Broccoli, etc.

In accordance with embodiments of the invention, the GUI 100 also collects information from which non-explicit information may be derived. As discussed above, non-explicit responses are any type of information that the user is not explicitly responding to, such as information related to the procedure or behavior of the user 102 while taking the survey. For example, the GUI 100 may collect information from which the server 130 can determine the order in which the user 102 selects response objects 222. Such non-explicit information may have additional value to the survey creator because if a user 102 feels strongly about a particular response, the user will most likely select that response first. In other words, the user 102 is prioritizing the particular selected objects 222 first, second, third, etc., in the order selected.

If the survey creator can collect information on a group of users 102 as to their priorities, this information can be invaluable for the survey creator to align its behavior with its customers' priorities. For example, suppose a grocery store receives 100 survey responses for customers. Eighty (80) customers' first responses were that they love cantaloupes, and 65 customers' second response was that they dislike string beans. This information may influence the grocery store to increase its stock of cantaloupes and lower its future order for string beans, beyond the level the grocery store may have adjusted its order merely based on leaving the explicit response that 65 customers dislike string beans. The non-explicit information may provide the grocery store with additional information to better determine the priorities and preferences of its customers as it relates to fruits and vegetables.

The GUI 100 may also identify the objects 222 that the user decides not to select, i.e., are left in the overview space 220. For example, in FIG. 4, the user has not selected the response objects Olives and Zucchini. The GUI 100 may also collect and provide this information to the server 140. The survey creator may assign a “neutral” value to the non-response, in which case the information may be considered an explicit pairing of Object-Neutral. However, if the survey creator does not assign a value but leaves it open for interpretation, then the non-response can be treated as a non-explicit response subject to further interpretation and analysis.

There are multiple ways to interpret a user's non-response, which may depend on a number of other factors. Suppose the user spent a lot of time on a survey 108 with few responses. Then it is possible that the user thought through the responses but decided against responding. If the user spent little time and answered with few responses, then it is more likely that the user may not have wanted to take the time to respond more exhaustively. The brevity of the polling period and the limited number of responses may indicate disinterest or carelessness.

The GUI 100 also collects information from which the time between placement of objects and/or the time between selecting and placing a particular object in a container 232-238 may be determined. Longer periods of time may be indicative of indecision or a low priority of a particular object 222, for example. Time stamps may be assigned to the selection and placement of objects 222 and the input of objects, when the respective event takes place, for example. The time stamps may be provided to the server 130 for analysis, as discussed below.

Similarly, if a user 102 changes a response, the user may feel less strongly about the placement of a particular object 222. Such a response may have less value to the survey creator. The number and types of changes made by the user 102 may also provide insight into the user and the value to be afforded that user's responses. For example as to the number of changes, if the user decides to decouple the pairing Love-Banana by selecting the response object Banana and dragging and dropping Banana into the “Like” container, that change in response is recorded as a non-explicit response, while the new pairing of Like-Bananas is recorded as an explicit response. It could be that the user is not confident whether he loves or likes bananas and changes his answer regarding bananas multiple times. Each of those changes may be collected by the GUI 100 and provided to the server 140 for analysis.

For example, suppose the user selects, drags and drops broccoli in the “love” response container, but then changes the answer to “hate.” Suppose the user 102 then again changes the answer from “hate” to “like.” Such dramatic swings in answers may provide insight into whether the user 102 was careless about the response or whether the user was faking the response. Information about the dramatic range or swing in responses can be collected by the server 140 and presented to a survey analyst for analysis to determine whether the user 102 faked the last changed response, while his first response was initially honest, for example.

Based on collecting the above non-explicit responses, one embodiment of the present invention provides valuable information to survey creators and analysts to probe deeper into a user's survey responses by analyzing and attributing measures for confidence measures, importance, carelessness, and fakeness of each explicit response.

2. Quicker Response Time and Increased Survey Completion Rate

In the typical electronic survey in the prior art, the user answers each question on the page and, if there are more survey questions, navigates to the next page of questions. The user responds to and navigates through each page until the survey is complete. This process can be time consuming and may even discourage the user from completing the survey.

Surveys in accordance with embodiments of the invention may alleviate these problems by providing a more compact, easier to use and more interactive survey. For example, a user 102 may decide that they only want to respond to one question after having looked at all the response objects in the overview space. The user 102 then clicks “Complete” or “Move to the Next Survey.” By allowing a user to decide when a certain survey page is complete, the rate of completion is increased even if there are only a few responses. While there may only be one pairing because almost all of the response objects were left in the overview space, that information is presented to the survey creator or analyst for interpretation. If the user 102 spent ten minutes on the survey but only provided one answer, a survey analyst may interpret that as the user has no opinion as to those response objects left in the overview space. If the user spent only ten seconds and provided one answer, a survey analyst may deduce that the user has no interest in the survey. Nevertheless, the collection and presentation of explicit and non-explicit information provides information for the survey analyst to interpret while providing the possibility for the user to examine all the questions and/or statements for response before deciding when he wants to complete the survey. Survey results may be at least partially interpreted by the server 130 automatically, as well.

Suppose there were twenty-five questions presented. In the traditional electronic survey, the user 102 may need to answer each question in order and there may be five pages of the survey to complete.

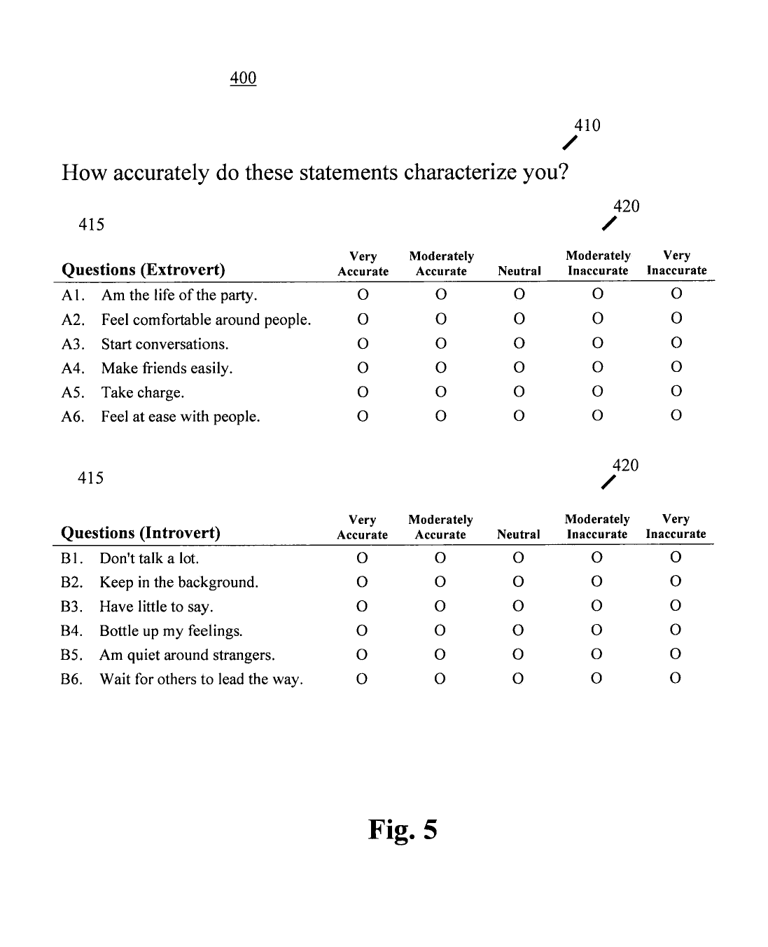

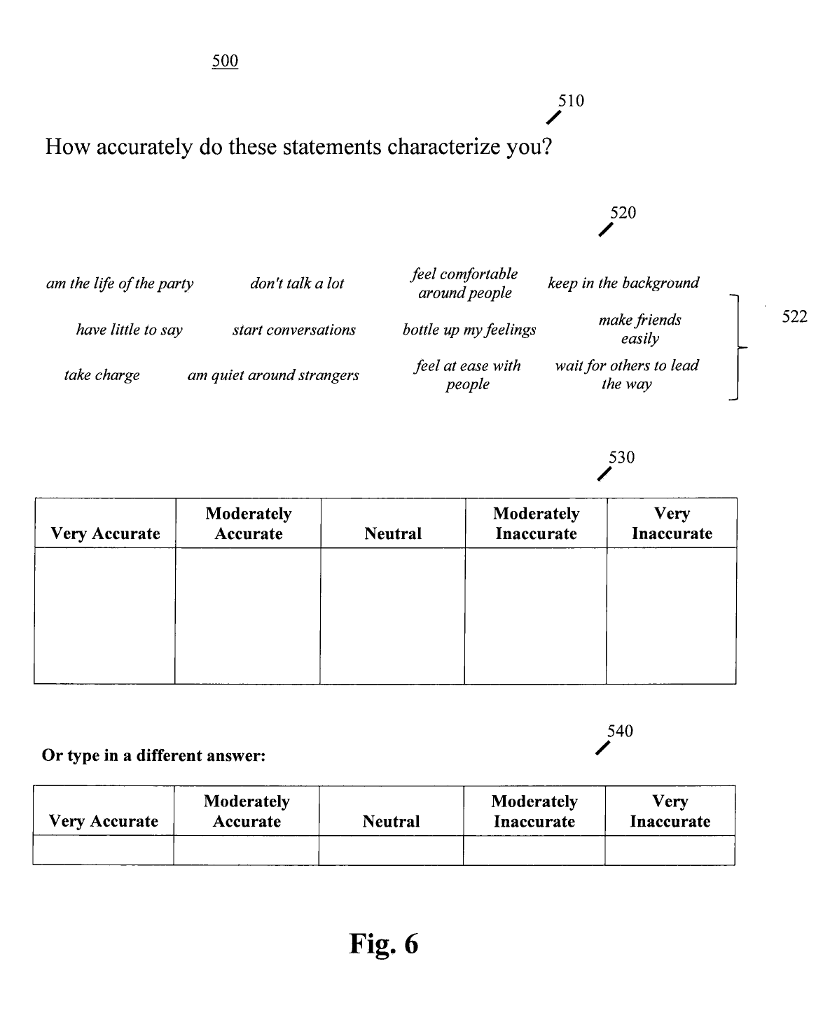

FIGS. 5 and 6 illustrate another example of a survey presented in accordance with an embodiment of the invention, that may be used in in personality testing, for example. FIG. 5 is an example of a traditional survey presented by a GUI 400 used to determine whether a user is an extrovert or an introvert. The topic 410 is “How accurately do these statement characterize you?” Twelve questions 415 (A1-A6, B1-B6) are provided with the same set of prescribed Likert scale responses 420: (a) very accurate, (b) moderately accurate, (c) neutral, (d) moderately inaccurate, and (e) very inaccurate. While all twelve questions are provided on the same survey page in FIG. 5, in some cases, a GUI may only present six questions per page, for example. Then, in order for a user 102 to complete a survey as in FIG. 5, the user would need to navigate through two pages. If there are thirty questions instead of twelve, for example, then the user 102 would need to navigate through five pages. The user 102 may get tired or bored of the survey and quit after the first few pages without having seen rest of the survey.

FIG. 6 is an example of GUI 500 presenting an electronic survey corresponding to the survey in FIG. 5, in accordance with an embodiment of the invention. The GUI 500 has a narrative space 210 with the question “How accurately do these statement characterize you?”, as in FIG. 5. An overview space 520 including objects 522, a response space 530 containing containers assigned relative ratings, and an input space 540 are also provided, as described above with respect to FIGS. 3 and 4. Twelve objects 222 are presented at one time in this example. Additional response objects may dynamically appear and replace response objects that have been selected, as well. In this example, the user 102 does not, therefore, need to navigate to another page, even if additional objects 222 are provided.

By allowing the user to direct the progress of his responses on one page or one interface instead of paging through a traditional electronic survey, the application will speed the survey process and increase the rate of completion.

3. Collection of Explicit and Non-Explicit Responses

### 3.1 History Events Objects

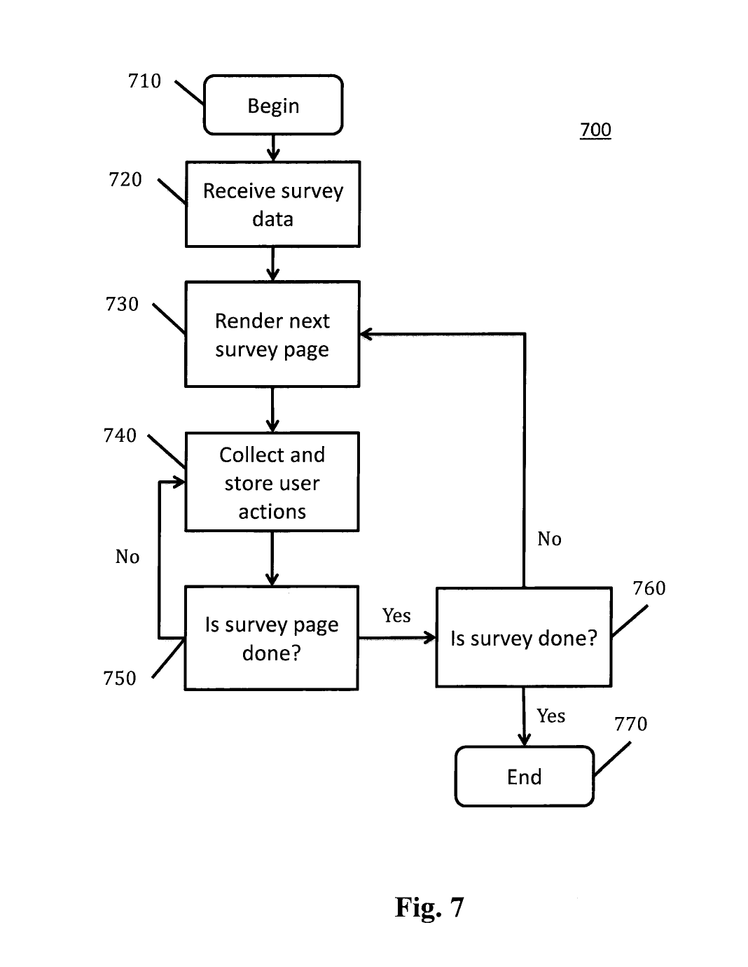

FIG. 7 is a flow diagram showing an example of a process 700 for presenting the graphical user interface 100 and recording responses from the user 102 during a polling period during which the user 102 or survey taker is taking a survey 108. The process begins in Step 710, when a user 102 accesses a survey by their computing device 104 via a link provided in an email, for example.

Data defining the electronic survey is received, in Step 720. The finest unit in describing a survey is a “survey page”. A survey is logically designed to have a set of survey pages. In one example of a survey page, the page contains the following fields: Page ID, the narrative about the survey page and the intended use of the page, and a set of prescribed objects and a set of prescribed scales. In one example, the server 130 provides this information to the computing device 104 in the form of a Survey Page Object, along with Javascripts. The browser on the computing device 104 constructs the GUI 100 in the form of a Javascript enhanced web page based on the Survey Page Object and the Javascripts, in a manner known in the art, in Step 730. Table 1, below, is an example of a Survey Page Object.

TABLE 1
Survey Page Object

| Fields of a Survey | |
|---|---|
| Page | Field Explanation |
| Page ID | Identifier of survey page |
| Narrative | Description and/or directions for this survey |
| | page |
| Prescribed Objects | Set of objects provided by the survey |
| | designer |
| Prescribed Scales | Set of Likert scales provided by the survey |
| | designer |

As the user 102 takes the survey 108, the browser collects and stores information related to the user actions in memory of the computing device 104, in Step 730. User actions may be stored in the form of Survey History Objects, each having a Survey ID, a current start time, and the survey taker's IP address, for example. In this example, whenever a user 102 places an object 222 in a response space 232-238 or enters a new object into the input space 240, a History Event Object is generated and associated with the survey page by the browser on the computing device 104. This association may be provided through Page History ID, for example. Another key field in a History Event Object is the “Action” field, which can take on four different values: SELECT, UNSELECT, ADD, and REMOVE. SELECT and UNSELECT are for handling response objects 222 in the overview space 220. ADD and REMOVE are for handling objects not in the overview space 220 and entered by the user 102 into the input region 240. Examples of History Event Objects are provided below in Tables 2-7.

If the survey taker selects and drags a prescribed response object (“Lemons”) in the overview space 320 and drops the response object in the response space (“Hate”) 330, the History Event that is generated has the properties in Table 2, below.

TABLE 2
Example History Event Object for a user SELECT Action

| | |
|---|---|
| Object ID | The database ID of “Lemons” |
| Scale ID | The database ID of “Hate” |
| Action | SELECT |
| Time | The time when the object is dropped into the |
| | response scale |
| Prescribed | True; this object was prescribed by the survey |
| | creator |
| Page History ID | The page history ID generated with the web |
| | page |
| Text Input | null; prescribed objects don't have free text |
| | input |

Suppose the survey taker changes his mind about “Lemons” and decides to move the response object to “Dislike”. A History Event is generated as a new SELECT action as in Table 3, below. It is not necessary to have a MOVE action, because the server 130 can later tell that “Lemons” has been moved based on the fact that in the database there are two SELECT events about the “Lemons” object.

TABLE 3
Example History Event Object for a user SELECT Action

| | |
|---|---|
| Object ID | The database ID of “Lemons” |
| Scale ID | The database ID of “Dislike” |
| Action | SELECT |
| Time | The time when the object is dropped into the |
| | response scale |
| Prescribed | True; this object was prescribed by the survey |
| | creator |
| Page History ID | The page history ID generated with the web |
| | page |
| Text Input | null; prescribed objects don't have free text |
| | input |

Suppose the survey taker 102 responds to Blueberries, a prescribed response object, with “Love.” The History Event generated looks like the following Table 4.

TABLE 4
Example History Event Object for a user SELECT Action

| | |
|---|---|
| Object ID | The database ID of “Blueberries” |
| Scale ID | The database ID of “Love” |
| Action | SELECT |
| Time | The time when the object is dropped into the |
| | response scale |
| Prescribed | True; this object was prescribed by the survey |
| | creator |
| Page History ID | The page history ID generated with the web |
| | page |
| Text Input | null; prescribed objects don't have free text |
| | input |

Suppose the survey taker 102 eventually decides to move “Lemons” back into the overview space, thus choosing to disassociate “Lemons” from the previously chosen scale. The History Event generated then looks like the following. The action recorded in this case is UNSELECT, which is shown in Table 5, below.

TABLE 5
Example History Event Object for a user UNSELECT Action

| | |
|---|---|
| Object ID | The database ID of “Lemons” |
| Scale ID | The database ID of “Dislike” |
| Action | UNSELECT |
| Time | The time when the object is dropped into the |
| | response scale |
| Prescribed | True; this object was prescribed by the survey |
| | creator |
| Page History ID | The page history ID generated with the web page |
| Text Input | null; prescribed objects don't have free text input |

Suppose the survey taker 102 decides to type in a response that is not provided in the overview space 220. The survey taker clicks into the “Love” column of the response space 230, and types “Bok Choy.” The “Bok Choy” object is created and displayed in the “Love” response column of the response space 340. After the survey taker has completed his typed-in response, a new History Event is generated in Step 740, with the following properties and sent asynchronously to the Web Server 630.

TABLE 6
Example History Event Object with an ADD Action

| | |
|---|---|
| Object ID | null; Non-prescribed objects don't have database IDs |
| Scale ID | The database ID of “Love” |
| Action | ADD |
| Time | The time when the object is dropped into the response |
| | scale |
| Prescribed | False; this object was not defined by the survey creator |
| Page History ID | The page history ID generated with the web page |
| Text Input | “Bok Choy” |

Suppose the survey taker changed his mind about “Bok Choy” and has decided to remove “Bok Choy” from the “Love” column of the response space 330. The survey taker removes this typed-in response, and a new History Event is generated in Step 740, FIG. 7 with the following properties.

TABLE 7
Example History Event Object with a REMOVE Action.

| | |
|---|---|
| Object ID | null; Non-prescribed objects don't have database IDs |
| Scale ID | The database ID of “Love” |
| Action | REMOVE |
| Time | The time when the object is dropped into the response |
| | scale |
| Prescribed | False; this object was not defined by the survey creator |
| Page History ID | The page history ID generated with the web page |
| Text Input | “Bok Choy” |

When the survey taker 102 no longer changes any selections, the final response in the form of a pairing, i.e., “Lemons-Dislike” is recorded and a History Event Object is generated, in Step 740.

### 3.2 Recording and Communication

As soon as a History Event has been created, the browser sends the respective History Event Object to the server 130 in real time through the Javascript executing the GUI 100, via the network 140. Although not required, for performance reasons, the SEND operation can be implemented in a Javascript thread in the browser that is dedicated to communication between the computing device 104 and the server 130, for example.

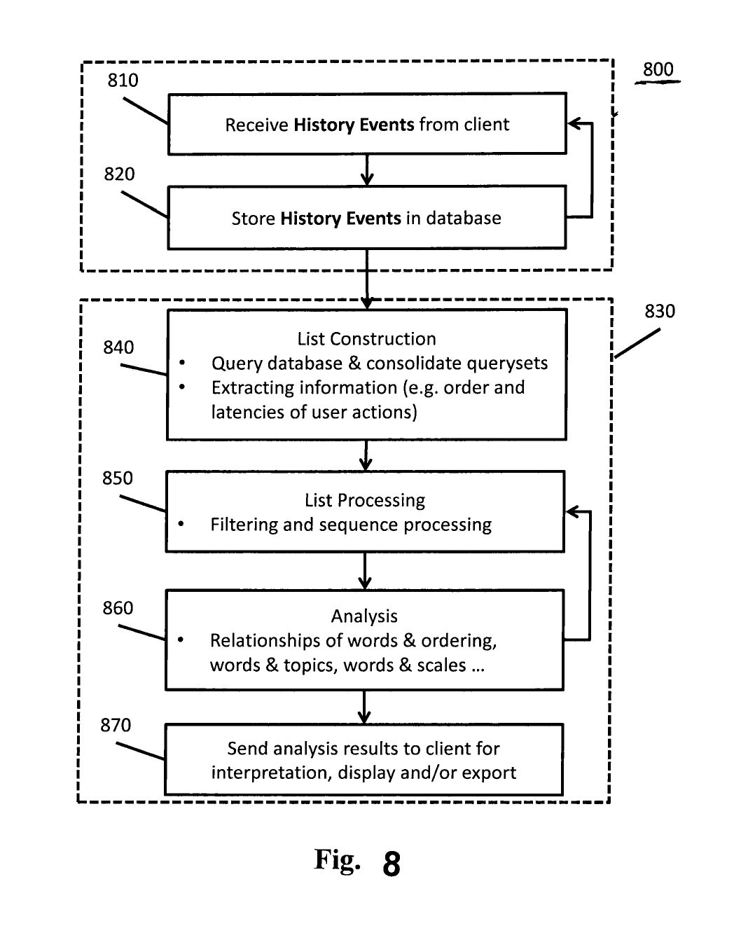

On the server side, the server 130 simply passes the History Event Objects received to the database server 150 for storage, as discussed below with respect to FIG. 8.

While in this example, History Event Objects are created when an object 222 is dropped or inserted into a response space 230, 240, History Event Objects may also be created when an object is first selected.

This may enable derivation of additional non-explicit information, such as the time it takes to place a selected object into a response space. When it is determined that a survey page is done, such as by receiving a Next Page entry by the user 102, in Step 750, it is determined by the browser on the computing device 104 whether the survey is done, in Step 760. This can be determined by the browser if the last page is done, for example. If so, processing of the survey is ended, in Step 760. If not, then the next survey page is rendered by the browser, in Step 730, as discussed above.

4. Analytic of User Interaction Data

### 4.1 User Interaction History

FIG. 8 is a flow diagram of an example of a process 900 for processing and analyzing survey results, in accordance with an embodiment of the invention. History Event Objects are received by the server 130 from a client computing device 104 via the network 140 as the user 102 takes the survey, in Step 810. The History Event Objects may be received in real-time, for example. The server 130 stores the History Event Objects in the database 150, in Step 820.

The data is analyzed in Step 830, which includes Steps 840-870. Data analytics on the results collected on prescribed objects (the objects in the overview space 220) and non-prescribed objects (objects not in the overview space 220 and input by the user 102) revolve around the user interaction history, where pairing decisions are kept in temporal order. For ease of description, we use the following symbolic representations:

| | |
|---|---|
| t ∈ [0, n − 1] ⊂ N | t is an integer ID that identifies the survey taker, where |
| | n is an integer representing the number of survey takers. |
| w ∈ [0, m − 1] ⊂ N | w is an integer ID that identifies the key word or phrase, |
| | where m is an integer representing the number of key |
| | words or phrases in a survey. |
| s ∈ [0, p − 1] ⊂ N | s is an integer ID that identifies the scale, where p is an |
| | integer representing the number of scales, or opinion |
| | boxes in a survey. |
| o ∈ [0, q − 1] ⊂ N | o is an integer ID that identifies the sequential order of |
| | interactions, where q is an integer representing the |
| | maximum number of interactions taken by survey takers. |
| l ∈ R | l is a REAL number that represents the latency recorded |
| | between consecutive interactions by survey takers. |
| a | a is an enumerated type, representing the kind of action |
| ∈ {SELECT,UNSELECT} | recorded in a user interaction. |

Under this framework, the user interaction history is a list of tuples. We refer to this list as the history list (H), and each tuple consists of:
(t,w,s,o,l,a).

In the H list, the tuples belonging to the same survey taker 102 appear in the order of interaction, with the first tuple having a value of zero in the latency field, l, as well as having a value of zero in the order field, o. For subsequent interactions by the survey taker 102, the order field monotonically increments and the latency field is computed as differences in time between two consecutive interactions.

The H list is constructed from the database 150 and analyzed in, Step 840. The list processing Step 8950 and analysis Step 860 can iterate in a feedback loop, as shown in FIG. 89. Some examples of analytical purposes are to measure every keyword's relative priority, or to group survey takers according to common patterns in the way they have interacted with the survey. Depending on the analytical purpose, the workflow of processing and analysis varies.

The H List of user interaction history is constructed by the server 130, in Step 840. The five database tables related to constructing the H list are listed in Table 8, below. The construction process will be demonstrated using the example survey of food preferences. Suppose the survey ID is 101. A query on the Survey History table by the survey ID returns all of the survey takers 102 that have responded to the survey. Querying on the Survey table by the survey ID returns the IDs of the survey pages in that survey. The detailed information of each survey page is in the Survey Page table. Suppose the 2^{nd} page in the survey is the Answer Cloud question to analyze. A query on the Page History table by survey ID and/or survey page ID, such as 2, returns the IDs of the related History Event objects, which can be queried and retrieved from the History Events table. Examples of History Event Objects are discussed above and shown in Tables 2-7.

TABLE 8
Database Tables Used in Data Analytics

| | Information Contained in the Respective |
|---|---|
| Database Tables | Table |
| Survey History | Information about a survey taker (which |
| | survey, time of taking the survey and then |
| | IP address) |
| Survey | Information about each survey (which pages |
| | belong to this survey) |
| Survey Page | Information about each page in the survey |
| Page History | Information about which history events |
| | records the action by a survey taker on each |
| | survey page |
| History Events | Information about each action taken by |
| | survey takers on an Answer Cloud survey |
| | page |

By filtering for History Event Objects with “Prescribed” field being true and then ordering the objects by time, we can find out the order in which each particular survey taker interacted with the Prescribed Objects. Non-prescribed objects may be similarly analyzed. On the temporally sorted list of History Event Objects, the latency incurred by a survey taker while taking actions during the survey is the difference between any two consecutive interactions. After filling in the latency and ordering information, the list of History Event objects become transformed into the H list.

### 4.3 List Processing

H list processing is performed in Step 950 for two purposes: (1) to ensure data quality by removing extraneous data and (2) for drill-down analysis by filtering for tuples that meet particular requirements. List processing can be done either through filtering based on queries or by way of sequence processing, for example.

An example heuristic to ensure data quality is that survey inputs are less reliable when a survey taker has provided very few pairing decisions at the end of the survey. In another example, based on the probability distribution function of latency on a per survey taker basis, Pₜ(l), when both the mean value and the variance of Pₜ(l) are small, this survey taker, t, has a strong tendency of carelessly proceeding through the survey.

For drill-down analysis, one example is to narrow the H list down to a subset of survey takers selected by geographic region, time of taking the survey, or other demographic information. Some other examples are to query for the SELECT interaction events only, or to query for interaction events involving a specific subset of key words identified through analytics methods, including but not limited to those described in Section 4.4.

Traversing the H list enables sequence processing. For example, the server 130 determines whether and how many times a survey taker 102 has changed an opinion about a prescribed object 222 and then the final pairing decision. In another example, the server 130 traverses the H list and keeps only those survey takers 102 whose first five pairing decisions universally reflect positive opinions, thereby drilling down to that specific group of survey takers.

### 4.4 Analysis

After the H List is created in Step 840 and processed in Step 850, it is ready for analysis, in Step 860. There are multiple ways to perform the analysis. The survey creater, administrator, or survey giver, for example, may select the analysis or analyses to perform. Examples of H List analyses that may be used are described below. Other techniques may also be used instead of or along with any or all of these techniques.

### 4.4.1 Analysis: Word-Order Relationship

There are two ways to compare key words (objects 222) according to the order in which all of the survey takers picked them. This ordering information can serve as the basis for inferring survey takers' confidence regarding their opinions or the strength of their opinions.

Method 1: let M_{wo} be a m×q matrix where matrix element p_{wo} is the probability of survey takers choosing the word, w, in the o^{th} interaction. The matrix can be illustrated as the following table:

| | o₁ | o₂ | o₃ | o₄ | . . . |
|---|---|---|---|---|---|
| w₁ | 0.3 | 0.1 | 0.05 | 0.03 | . . . |
| w₂ | 0.01 | 0.01 | 0.02 | 0.02 | . . . |
| W₃ | 0.02 | 0.03 | 0.01 | 0.11 | . . . |
| . . . | . . . | . . . | . . . | . . . | . . . |
| . . . | . . . | . . . | . . . | . . . | . . . |

Each row of M_{wo} is specific to a different key word, w, in the survey 108. Based on each row, an ordering score (OS) can be computed as: OS_{w}=Σₒ₌₀^{q}cₒ×p_{wo}, where cₒ is a co-efficient predetermined for each of the o^{th} sequential interaction order that ranges from the 1^{st} step to the q^{th} step. A simple example is to use a linear ramp function that assigns a high co-efficient value for the 1^{st} step and a low co-efficient value for the q^{th} step.

Method 2: let PO be a m×m matrix, below, where every matrix element p_{w}_{₁}_{w}_{₂} is the probability of survey takers picking key word, w₁, before key word, w₂. This matrix records the ordering between key words. It is asymmetric, and p_{w}_{₁}_{w}_{₂}+p_{w}_{₂}_{w}_{₁}=1 holds true.

| | w₁ | w₂ | w₃ | w₄ | . . . |
|---|---|---|---|---|---|
| w₁ | 0 | 0.1 | 0.98 | 0.29 | . . . |
| w₂ | 0.9 | 0 | 0.97 | 0.37 | . . . |
| w₃ | 0.02 | 0.03 | 0 | 0.11 | . . . |
| w₄ | 0.71 | 0.63 | 0.89 | 0 | . . . |
| . . . | . . . | . . . | . . . | . . . | . . . |

The key words can then be sorted using any sorting algorithm, as long as the comparison function references the PO matrix. The following is one such example. It is presented for illustrative purposes, not as a limitation of embodiments of the invention.

Below is a sample compare function for sorting key words according to the order in which the survey takers interacted with the words:

#define num_key_words 18
float PO[num_key_words][num_key_words]; /* the PO
matrix */
int compare (int word1, int word2)
{

/* word1 and word2 are integer IDs in the range of [0,

num_key_words−1] */

if (PO[word1][word2] > PO[word2][word1])

return 1;

if (PO[word1][word2] < PO[word2][word1])

return −1;

return 0;

}

### 4.4.2 Analysis: Word-Topic Relationship

Let M_{wt}(o) be a m×n matrix where every matrix element b_{wt} is a binary value recording to whether survey taker, t, has chosen the word, w, by the o^{th} interaction. Every row corresponds to a key word, while every column represents a survey taker. The matrix can be illustrated as the following table. M_{wt}(o) is inherently sparse as long as o is a small value, such as 3 or 5.

| | t₁ | t₂ | t₃ | t₄ | . . . |
|---|---|---|---|---|---|
| w₁ | 0 | 0 | 1 | 0 | . . . |
| w₂ | 0 | 1 | 0 | 0 | . . . |
| w₃ | 1 | 0 | 0 | 0 | . . . |
| . . . | . . . | . . . | . . . | . . . | . . . |
| . . . | . . . | . . . | . . . | . . . | . . . |

M_{wt}(o) is useful for analyzing word-topic relationship. One method is to use various types of clustering algorithms to discover columns with exactly the same values, thus finding clusters of survey takers that have responded to the same set of key words during the early steps when interacting with a survey question, for example. A “topic” is defined as the common set of key words that a cluster of survey takers have chosen to interact with first. It is reasonable to infer that the cluster of survey takers care the most about the key words in the corresponding topic the most. Topics could have overlapping key words, and each key word may belong to multiple topics. Survey takers 102 can each be related to only one topic.

Another method is to use M_{wt}(o) to cast this analysis under the framework of latent semantic indexing. By performing a reduced rank singular value decomposition, M_{wt}(o) becomes:

M_{wt}(o)=UₒVₒWₒ*

For every predetermined o value, the meaning of U, V, W matrices are the following. V is an r×r square matrix, where r is the number of topics defined as a group of related key words. W* is a conjugate transpose of W, where W is an n×r matrix that relates individual survey takers to topics, in essence which topics each individual survey taker cares the most about. U is a m×r matrix that reveals how individual key words together form topics in a survey-audience specific manner. In this case, each key word can belong to multiple topics, and each survey taker can also care about multiple topics.

These two methods are provided as examples of word-topic analysis. There are other ways to analyze the M_{wt}(o) matrices, as would be apparent to one of ordinary skill in the art.

### 4.4.3 Analysis: Word-Scale Relationship

Let S_{ws}(o) be a m×k matrix where every matrix element P_{ws} is a probability that survey takers have paired this word, w, with this scale, s, by the o^{th} interaction. The matrix can be illustrated as the following table, assuming there are five scales (k=5):

| | s₁ | s₂ | s₃ | s₄ | s₅ |
|---|---|---|---|---|---|
| w₁ | 0.3 | 0.1 | 0 | 0 | 0 |
| w₂ | 0.1 | 0.1 | 0.1 | 0.3 | 0 |
| w₃ | 0 | 0 | 0 | 0 | 0.3 |
| . . . | . . . | . . . | . . . | . . . | . . . |
| . . . | . . . | . . . | . . . | . . . | . . . |

The S matrix reveals the frequency in which each pairing has taken place during user interactions up to the o^{th} step of interaction. For example, max_{w}(maxₛ(P_{ws}(o))) reveals the pairing that has received the most input by the o^{th} step. When o=q, q is an integer representing the maximum number of interactions taken by survey takers, P_{ws}(q) becomes the final pairing result.

Let dS_{ws}(o) be a m×k matrix where every matrix element P_{ws} is probability of survey takers have not initially paired this word, w, with this scale, s, but have changed this word's pairing to be with that scale, s, by the o^{th} interaction. The matrix can be illustrated as the following table, assuming k=5:

| | s₁ | s₂ | s₃ | s₄ | s₅ |
|---|---|---|---|---|---|
| w₁ | 0 | 0.03 | 0 | 0 | 0 |
| w₂ | 0 | 0 | 0.1 | 0 | 0 |
| w₃ | 0 | 0 | 0 | 0 | 0 |
| . . . | . . . | . . . | . . . | . . . | . . . |
| . . . | . . . | . . . | . . . | . . . | . . . |

The dS matrix reveals the probability that each pairing is a result of a thoughtful choice made by a survey taker 102 during user interaction up to the o^{th} step of interaction.

### 4.5 Dissemination of Analysis Results

The analysis described herein provide the analytical results, which are then interpreted before being disseminated to the users (i.e. the survey administrator, survey creators, or survey givers, for example), in Step 870. The interpretation of the results may depend on factors such as the context of the survey 108, how the survey questions are asked, and the personal traits of each survey taker 102, for example.

In a common setting, for example, if a survey question asks survey takers 102 to rate a set of food items according to their perceived value for healthy eating, for example, the most prevalent order in which the survey takers interact with words is likely to correlate with the relative importance among the food items. In other settings, the prevalent ordering could correlate with the relative strength of the survey takers' opinions toward the prescribed response objects 222 in the survey. When detailed distinctions are not necessary, one could present such information as relative priority among the response objects.

Similarly, there are other ways to correlate information about the word-order, word-scale, and work-topic relationships with relative priority, uncertainty and hesitation of people's opinions.

Examples of implementations of the invention are described above. Modifications may be made to these examples without departing from the spirit and scope of the invention, which is defined in the claims, below.

We claim:

1. A system for conducting electronic surveys, comprising:
a processing device coupled to a network; and
storage;
wherein the processing device is configured to:
provide a graphical user interface defining a survey for presentation on a display of a computing device for a user taking the survey, via the network;
the graphical user interface configured to:
define at least one survey page comprising:
a first region including a plurality of different objects selectable by a user taking the survey, the objects related to a survey question;
define a second region separate from the first region, the second region defining at least a first portion assigned a first relative rating on a rating scale and a second, different portion assigned a second, different relative rating on the rating scale, for selective placement of objects from the first region by the user, in response to the question;
wherein the graphical user interface is configured to provide data related to the placement of each object into the first and second portions by the user, for each placement, via the network, while continuing to display each selection on the same survey page;
wherein the processing device is further configured to:
store the data in memory;
derive explicit information identifying the relative rating on the rating scale for each placed object, from the stored data;
derive additional, behavioral information related to the placement of respective objects, from the stored data.

2. The system of claim 1, wherein the graphical user interface is configured to provide an additional, different object in the first region to replace an object selected and placed by the user into a portion of the second region.

3. The system of claim 1, wherein the graphical user interface is configured to define at least one additional portion assigned at least one different, relative rating on the rating scale, in the second region.

4. The system of claim 3, wherein the rating scale is a Likert scale.

5. The system of claim 1, wherein the objects are selected and placed by a user via a mouse cursor or by touching a touch screen.

6. The system of claim 1, wherein the additional, behavioral information comprises an order of placement of objects, changing a placement of an object, and/or a length of time to place a selected object.

7. The system of claim 6, wherein the graphical user interface is further configured to:
assign time stamps to selected objects when a respective selected object is placed; and
provide the respective time stamps in association with the data related to each placement to the processing device;
wherein the processing device is further configured to derive at least certain, additional, behavioral information based, at least in part, on respective time stamps.

8. The system of claim 1, wherein the graphical user interface is further configured to:
define a third region separate from the first and second regions, the third region comprising at least one portion assigned a relative rating on the rating scale; and
allow the user to input an object or a name of an object not in the first region, in one of the at least first and second portions defined in the second region; and
provide second data related to the input and relative rating of the input, to the processing device;
wherein the processing device is further configured to:
store the second data; and
derive the explicit information and/or additional, behavioral information, from the second stored data.

9. A method for conducting an electronic survey, comprising:
providing a graphical user interface defining a survey page to a computing device for display to a user taking the survey, by a processing device, via a network;
receiving a placement of a selected object into one of at least two portions of a second region separate from the first region, by the user in response to the question, wherein each of the at least two portions are assigned a relative rating on a rating scale, via the network, by the processing device;
storing the data in memory, by the processing device;
deriving explicit information identifying the relative rating on the rating scale for each placed object from the stored data, by the processing device; and
deriving additional, behavioral information related to the placement of respective objects from the stored data, by the processing device.

10. The method of claim 9, wherein the graphical user interface provides an additional, different object in the first region to replace an object selected and placed by the user into one of the at least two portions.

11. The method of claim 10, wherein deriving the additional, behavioral information comprises deriving:
an order of placement of objects, a change in placement of an object, and/or a length of time to place a selected object.

12. The method of claim 11, further comprising:
receiving first time stamps for selected objects when a respective selected object is selected;
receiving second time stamps for selected objects when a respective selected object is placed; and
deriving the additional, behavioral information based, at least in part, on the received first and second time stamps.

13. The method of claim 9, further comprising:
receiving an object or a name of an object not in the first region, input in a third region different from the first and second regions, in a portion assigned a relative rating on the rating scale, by the user;
storing second data related to the input and relative rating of the object; and
deriving explicit information and/or additional, behavioral information from the second stored data.

14. A graphical user interface for conducting electronic surveys via a display of a computing device, comprising:
a first region including a plurality of objects selectable by a user taking the survey, the objects related to a survey question; and
a second region separate from the first region, the second region defining at least a first portion assigned a first relative rating on a rating scale and a second, different portion assigned a second, different relative rating on the rating scale, for selective placement of objects from the first region by the user, in response to the question;
wherein the graphical user interface is configured to store on the computing device data related to the placement of each object into the first and second regions by the user, for each placement, while continuing to display each selection on the same survey page.

15. The graphical user interface of claim 14, wherein the graphical user interface is configured to define the first and second regions and provide the data by Javascripts.

16. The graphical user interface of claim 14, further configured to provide an additional, different object in the first region to replace an object selected and placed by the user into the first or second portion.

17. The graphical user interface of claim 14, configured to define at least one additional portion assigned at least one different, relative rating on the rating scale, in the second region.

18. The graphical user interface of claim 17, wherein the rating scale is a Likert scale.

19. The graphical user interface of claim 14, configured to receive selections and placements of the via a mouse cursor or by touch on a touch screen.

20. The graphical user interface of claim 14, wherein the graphical user interface is further configured to:
assign time stamps to selected objects when a respective selected object is placed; and
store the respective time stamps in association with the data related to each placement.

21. The system of claim 14, wherein the graphical user interface is further configured to:
define a third region separate from the first and second regions, the third region comprising at least one portion assigned at least one respective relative rating on the rating scale; and
receive an input of an object or a name of an object not in the first region, in one of the at least one portions, entered by the user; and
store second data related to the input and relative rating of the object.
